(19) United States
(12) Patent Application Publication
(10) Pub. No.: US 2001/0017003 A1
(43) Pub. Date: Aug. 30, 2001

(54) Plant sleeve having a waxy layer

(75) Inventor: Donald E. Weder, Highland, IL (US)

Correspondence Address: Dunlap, Codding & Rogers, P.C., Suite 420, 9400 North Broadway, Oklahoma City, OK, 73114, US

(73) Assignee: Southpac Trust International, Inc.

(21) Appl. No.: 09/745,879

(22) Filed: Dec. 22, 2000

Related U.S. Application Data
(63) Continuation-in-part of application No. 09/076,231, filed on May 12, 1998, now abandoned.
Application No. 09/076,231 is a continuation of application No. 08/717,791, filed on Sep. 23, 1996, now abandoned.
Application No. 08/717,791 is a continuation-in-part of application No. 08/438,818, filed on May 11, 1995, now Pat. No. 5,557,882.

(51) Int. Cl. A01G 5/00; A47G 7/00

(52) U.S. Cl. 47/41.01

(57) ABSTRACT

A method of wrapping a floral grouping, preferably an orchid, with a wrapper which may be a sheet of material, a sleeve or a preformed pot cover. The wrapper is preferably constructed from a laminated material made up of at least a waxy layer and a support layer which are superposed upon each other and connected or laminated to each other. A second waxy layer may be connected or laminated to each other surface of the support surface. The waxy layer is made from a waxy material such as waxed paper, waxed tissue or high density polyethylene. The wrapped floral grouping may also contain a shredded material for cushioning the blooms of the floral grouping.

### CROSS-REFERENCE TO RELATED APPLICATIONS

The present application is a continuation-in-part of U.S. Ser. No. 09/076,231 filed May 12, 1998, entitled “PLANT SLEEVE HAVING A WAXY WRAPPER”, which is continuation of U.S. Ser. No. 08/717,791 filed Sep. 23, 1996, entitled “PLANT PACKAGE HAVING A WAXY WRAPPER”, which is a continuation-in-part of U.S. Ser. No. 08/438,818, filed May 11, 1995, entitled “PLANT PACKAGE HAVING A WAXY WRAPPER”, now U.S. Pat. No. 5,557,882, issued Sep. 24, 1996.

### BACKGROUND

The present invention relates to methods of wrapping floral groupings and potted plants with a wrapper, in particular, but not limited to, wherein the wrapper comprises a waxy material.

In the floral industry, when wrapping orchids for packing or shipment it is customary to use a waxy material such as a waxed paper or waxed tissue paper. The wrapping must be delicate so that it does not bruise or otherwise damage the delicate orchids. However, waxed tissue paper tends to compress in the package. When compressed in such a way, the waxed tissue paper loses its cushioning effect and thus does not function effectively to protect the orchids.

A wrapper constructed of a sheet of material which is relatively stiff while retaining the soft, cushioning effect of waxy material would be desirable for use in wrapping and packaging orchids and other floral types.

### BRIEF DESCRIPTION OF THE DRAWINGS

FIG. 1 is a perspective view of a laminated sheet of material used in accordance with the present invention.

FIG. 2 is an exaggerated cross-sectional view of the laminated sheet of FIG. 1.

FIG. 3 is a perspective view of a sheet of material having a floral grouping disposed thereon.

FIG. 4 is a perspective view of the floral grouping of FIG. 3 being wrapped in one method of wrapping.

FIG. 5 is a perspective view of the floral grouping wrapped in a conical fashion.

FIG. 6 is a perspective view of a method of using the sheet of material to wrap a floral grouping in a cylindrical fashion.

FIG. 7 is a perspective view of a potted plant such as may be wrapped by the method of the present invention.

FIG. 8 is a perspective view of a potted plant wrapped in accordance with one version of the present invention.

FIG. 9 is a perspective view of a floral sleeve used in accordance with the present invention.

FIG. 10 is a cross-sectional view of the sleeve of FIG. 9.

FIG. 11 is a perspective view of a sleeve used to wrap a floral grouping in accordance with the present invention.

FIG. 12 is a perspective view of a sleeve having a cinching element.

FIG. 13 is a perspective view of the sleeve of FIG. 11 used to wrap a floral grouping.

FIG. 14 is an elevational view of a sleeve having a detaching element constructed in accordance with the present invention.

FIG. 15 is a perspective view of the sleeve of FIG. 13 with a potted plant disposed therein.

FIG. 16 is a perspective view of a potted plant disposed in the sleeve of FIG. 13 after an upper portion of the sleeve has been removed to provide a pot cover having a skirt.

FIG. 17 is a perspective view of a preformed pot cover used in accordance with the present invention.

FIG. 18 is a perspective view of the preformed pot cover of FIG. 16 having a potted plant disposed therein.

FIG. 19 is a perspective view of a sheet of material having a shredded material and floral grouping disposed thereon.

FIG. 20 is a perspective view of the sheet of material and floral grouping of FIG. 18 conically wrapped.

FIG. 21 is a perspective view of a floral grouping and shredded material wrapped within a sleeve.

### DESCRIPTION

The present invention comprises a method of wrapping a floral grouping or potted plant, preferably an orchid. The method comprises providing the floral grouping or potted plant, providing a wrapper made from a sheet of material having a waxy or waterproof material laminated to one or both sides thereof and placing the wrapper about the floral grouping or potted plant forming a wrapped floral grouping or wrapped potted plant, respectively. The wrapper may be a laminated sheet of material or a sleeve or a preformed pot cover made from the sheet of laminated material. The wrapper may be further defined as having a portion which is detachable via a detaching element, such as perforations. The wrapper may have a bonding material disposed thereon for bondingly holding the wrapper about the floral grouping or potted plant.

The sheet of material (or other wrapper such as a sleeve or preformed pot cover) functions to substantially prevent or minimize damage by being less compressible when wrapped about a floral grouping than would be a wrapper made only from the sheet of waxy material used in forming the wrapper herein described. In other words, the wrapper claimed herein retains the benefits of a waxy wrapping material while adding the degree of stiffness necessary to reduce the chances that the wrapper will be excessively compressed against the floral grouping thereby causing damage to the floral grouping and especially to the bloom portion.

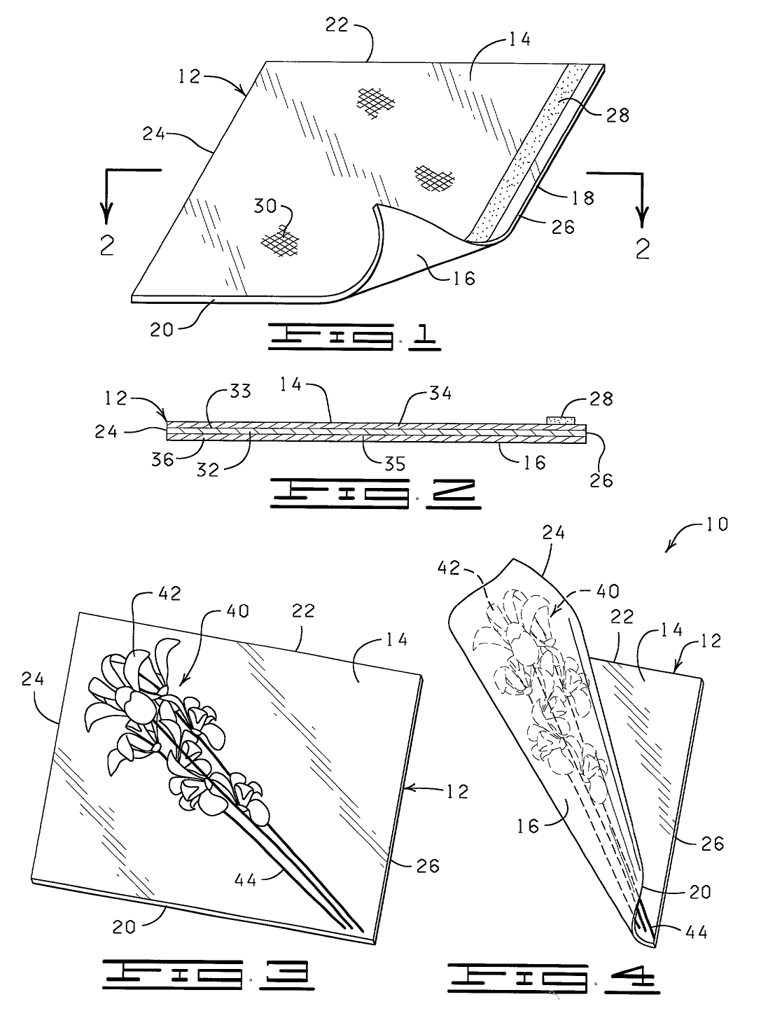

### The Embodiments of FIGS. 1-8

Referring now to FIG. 1, designated generally by the reference numeral 10 is a wrapper which is constructed in accordance with the present invention. The wrapper 10 is constructed from a laminated sheet of material 12. The sheet of material 12 has an upper surface 14, a lower surface 16, and an outer peripheral edge 18 (one corner of which is lifted for illustration purposes only) As shown in FIG. 1, the outer peripheral edge 18 of the sheet of material 12 comprises a first side 20, a second side 22, a third side 24, and fourth side 26. A bonding material 28 may optionally be disposed on at least a portion of one or both of the upper and/or lower surfaces 14 and/or 16 of the sheet of material 12, for example, as is illustrated in U.S. Pat. No. 5,181,364, the specification of which is hereby expressly incorporated herein by reference. A decorative pattern 30 may be printed upon all or a portion of the wrapper 10. Possible components of the decorative pattern 30 may be a lace-like pattern, geometric shapes, curly-cues, paisleys, swirls, squiggles, and any shapes generally associated with botanical items such as leaves, petals, stems, roots, fruits and any other biomorphic shapes. The decorative pattern 30 may comprise a single color or a plurality of colors.

The wrapper 10 may comprise the sheet of material 12 for wrapping a floral grouping or a flower pot; it may comprise a sleeve 66 for wrapping or covering a floral grouping or flower pot; or it may comprise a preformed pot cover 118 for covering a flower pot. Each of these versions of the present invention is described in more complete detail herein.

As noted above, the wrapper 10, when comprising the sheet of material 12, can be utilized to wrap a floral grouping or a flower pot. The term “flower pot” refers to any type of container used for holding a floral grouping or a plant. Examples of flower pots, used in accordance with the present invention include, but are not limited to, clay pots, wooden pots, plastic pots, pots made from natural and/or synthetic fibers, or any combination thereof. The flower pot is adapted to receive a floral grouping in the retaining space of the pot. The floral grouping may be disposed within the flower pot along with a suitable growing medium described in further detail below, or other retaining medium, such as a floral foam. It will also be understood that in some cases the floral grouping, and any appropriate growing medium or other retaining medium, may be disposed in a sleeve without a flower pot if the sleeve is adapted to contain a medium.

“Floral grouping,” as used herein, means cut fresh flowers, in particular orchids, artificial flowers, a single flower or other fresh and/or artificial plants or other floral materials and may include other secondary plants and/or ornamentation or artificial or natural materials which add to the aesthetics of the overall floral grouping. Further, the floral grouping may comprise a growing potted plant having a root portion as well. However, it will be appreciated that the floral grouping may consist of only a single bloom or only foliage, or a botanical item (not shown), or a propagule. The term “floral grouping” may be used interchangeably herein with the term “floral arrangement”. The term “floral grouping” may also be used interchangeably herein with the terms “botanical item” and/or “propagule.”

The term “growing medium,” when used herein, means any liquid, solid or gaseous material used for plant growth or for the cultivation of propagules, including organic and inorganic materials such as soil, humus, perlite, vermiculite, sand, water, and including the nutrients, fertilizers or hormones or combinations thereof required by the plants or propagules for growth.

The term “botanical item,” when used herein, means a natural or artificial herbaceous or woody plant, taken singly or in combination. The term “botanical item” also means any portion or portions of natural or artificial herbaceous or woody plants including stems, leaves, flowers, blossoms, buds, blooms, cones, or roots, taken singly or in combination, or in groupings of such portions such as bouquet or floral grouping.

The term “propagule,” when used herein, means any structure capable of being propagated or acting as an agent of reproduction including seeds, shoots, stems, runners, tubers, plants, leaves, roots or spores.

In the embodiment of FIG. 1, the sheet of material 12 is square. It will be appreciated, however, that any shape or size of sheet of material 12 may be used to wrap a flower pot or a floral grouping as long as it is sufficiently sized and shaped to wrap and encompass the flower pot or floral grouping. For example, the sheet 12 may also comprise other shapes, i.e., rectangular, round, oval, octagonal, asymmetrical, or the like. And multiple sheets of material 12 may be used in a single circumstance to wrap a pot or floral grouping. Moreover, when multiple sheets of material 12 are used in combination, the sheets of material 12 need not be uniform in size or shape. Finally, it will be appreciated that the sheet of material 12 shown in all embodiments herein is generally flattened.

As mentioned above, and shown in FIGS. 1 and 2, the sheet of material 12 is constructed of a support sheet of material 32 having an upper surface 33 to which a first sheet of waxy material 34 has been laminated or otherwise connected and having a lower surface 35 to which a second sheet of waxy material 36 (the same or different from the first sheet of waxy material) has been laminated or otherwise connected. Preferably the inner support sheet of material 32 is constructed from paper, metal foil, polymeric film, non-polymeric film, fabric, cardboard, or laminations or combinations thereof. The support sheet of material 32 may be comprised of two or more layers of material. It will also be understood that the sheet of material 12 may be formed with only a first sheet of waxy material 34.

The first and second sheets of waxy material 34 and 36 may be a waxed paper, a waxed tissue or any waxed flexible material having cushioning properties. The waxy material may be a natural or synthetic polymeric film material having a surface with a waxy feel which provides a cushioning effect similar to the cushioning effect of a waxed paper or waxed tissue. The first and second sheets of waxy material 34 and 36 may be any material which provides the beneficial cushioning effects of a waxed material and which has a waxy feel or properties similar to the feel and properties of a substrate having a waxed surface. The first and second sheets of waxy material 34 and 36 may be a waterproof material which has the cushioning properties of a waxed paper or tissue. Such a waterproof waxy material would repel water thereby maintaining the cushioning effect of the material. Examples of such polymeric films having a waxy feel are a high density polyethylene film and a polyvinylchloride film such as are commercially available from Georgia-Pacific Corporation and Minipak of Columbia, South America, respectively.

Any thickness or stiffness of the wrapper 10 may be utilized in accordance with the present invention as long as the wrapper 10 is flexible and may be wrapped about at least a portion of a flower pot or a floral grouping, as described herein. Stiffer sheets may be scored to facilitate their folding. The support sheet of material 32 and the first and second sheets of waxy material 34 and 36, preferably have thicknesses of less than about 0.1 mil to about 30 mils. Typically, the support sheet of material 32 and the first and second sheets of waxy material 34 and 36 have thicknesses in a range of less than about 0.2 mil to about 30 mils. In a preferred embodiment, the support sheet of material 32 and the first and second sheets of waxy material 34 and 36 are constructed from single sheets of material having thicknesses in a range of from less than about 0.5 mil to about 2.5 mils.

The term “polymeric film” when used herein means a manmade polymer such as a polypropylene or a naturally occurring polymer such as cellophane. A polymeric film is relatively strong and not as subject to tearing (substantially non-tearable), as might be the case with paper or foil.

The sheet of material 12 may vary in color. Further, the sheet of material 12 may comprise other decorative patterns or designs in addition to the lace pattern which are printed, etched, and/or embossed thereon. In addition, the sheet of material 12 may have various colorings, coatings, flocking and/or metallic finishes, applied separately or simultaneously or may be characterized totally or partially by pearlescent, opaque, translucent, transparent, tinted, iridescent or the like, qualities. Each of the above-named characteristics may occur alone or in combination. Moreover, each surface of the sheet of material 12 may vary in the combination of such characteristics. An example of an ink which may be applied to the surface of the material to print the patterns and designs described is described in U.S. Pat. No. 5,147,706, which is hereby expressly incorporated herein by reference.

The sheet of material 12 has a width extending generally between the first side 20 and the second side 22, respectively, sufficiently sized whereby the sheet of material 12 can be wrapped about and encompass a floral grouping or a flower pot. The sheet of material 12 has a length extending generally between the third side 24 and the fourth side 26, respectively, sufficiently sized whereby the sheet of material 12 extends over a substantial portion of the floral grouping or flower pot when the sheet of material 12 has been wrapped about the floral grouping or flower pot in accordance with the present invention, as described in detail herein.

FIGS. 3-6 illustrate the use of the present invention in wrapping a floral grouping. The sheet of material 12 (which is shown with an optional strip of bonding material 28 in FIG. 1, but which is shown without a bonding material in FIGS. 3-6) is provided, either as an individual sheet of material 12 or from a pad of such sheets of material 12 or from a roll of material (not shown), by any method described herein or other method in accordance with the present invention. Apparatus for dispensing the sheet from a pad or roll of material are shown in U.S. Pat. Nos. 5,111,638 and 5,181,364, the specifications of which are hereby expressly incorporated by reference herein.

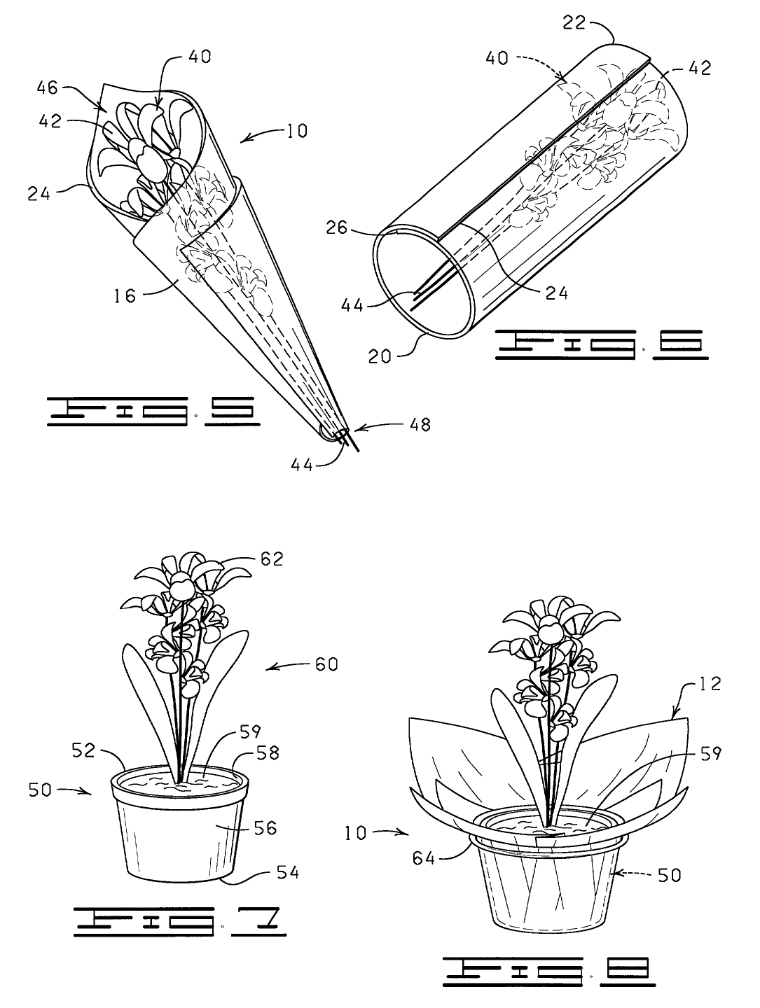

The bonding material 28, if present may have a backing or release strip (not shown). Such backings or release strips are well known to those of ordinary skill in the art. The backing or release strip may be left applied for a period of time to the bonding material 28 after it is disposed on an upper or lower surface 14 or 16 of the sheet of material 12 prior to its use as a wrapper 10, to protect the bonding qualities of the bonding strip. In operation, an operator may dispose the sheet of material 12 on a support surface (not shown), the lower surface 16 of the sheet of material 12 contacting the support surface. A floral grouping such as the one referred to in FIG. 4 by the general reference numeral 40 is then provided, and disposed upon the upper surface 14 of the sheet of material 12. The floral grouping 40 may be any floral grouping or botanical item as described elsewhere herein, but preferably comprises an orchid and generally has an upper portion 42, comprising a bloom or foliage portion and a lower portion 44, comprising a stem portion. The floral grouping 40 may be disposed upon the sheet 12 in a diagonal orientation as shown in FIGS. 3-5.

Referring to FIGS. 3 and 4, the sheet of material 12 is then wrapped about the floral grouping 40 by the operator, the operator overlapping a portion of the sheet of material 12 over another portion of the sheet of material 12. That is, for example, the operator places the first side 20 of the sheet of material 12 over the floral grouping 40, as shown in FIG. 4. The operator continues to roll the floral grouping 40 in the direction toward the fourth side 26 until the upper surface 14 near the fourth side 26 firmly engages the lower surface 16 of the sheet of material 12, wherein the floral grouping 40 is substantially encompassed by the sheet of material 12, and wherein the bonding material 28, if present, may contact the sheet of material 12 to substantially encompass and surround a substantial portion of the floral grouping 40. FIG. 5 shows the floral grouping 40 wrapped in a conical fashion with the upper portion 42 exposed near an open upper end 46 of the wrapper 10 and the lower portion 44 exposed near a lower end 46 of the wrapper 10.

In another embodiment, illustrated in FIG. 6, the sheet of material 12 is utilized to wrap the floral grouping 40. The floral grouping 40 is disposed upon the sheet 12 approximately parallel to third side 24 of the sheet of material 12. The sheet of material 12 is wrapped generally about the lower portion 44 of the floral grouping 40 to a position wherein the third side 24 generally overlaps the fourth side 26 in a cylindrical fashion. It should be noted that the sheet of material 12 may be wrapped a plurality of times about the lower portion 44 of the floral grouping 40 before the overlapping of the third side 24 and the fourth side 26. As before, the portion of the sheet of material 12 near the third side 24 is disposed generally adjacent another portion of the sheet of material 12 and the two adjacent portions then are brought into contact where they may be bondingly engaged thereby securing the sheet of material 12 generally about the floral grouping 40.

The sheet of material 12 (or any wrapper described elsewhere herein, such as the sleeve 66) once wrapped about the floral grouping 40 functions under ordinary handling conditions to substantially prevent damage to the blooms of the upper end 42 of the floral grouping 40 by crushing. Such damage may be, for example, breakage, bending, or bruising of the petals of the flowers or the blooms. By ordinary handling conditions is meant the manner typically employed in the floral industry to wrap floral groupings 40 for storage, shipping or sale, especially floral groupings 40 traditionally wrapped in waxed paper such as orchids.

In another version of the invention the sheet of material 12 may be used to wrap a pot with or without a botanical item therein, such as an orchid in bloom. Shown in FIG. 7 is a pot designated by the reference numeral 50 and which has an upper end 52, a bottom end 54, an outer peripheral surface 56, an inner retaining space 58 within which may be disposed a growing medium 59. The pot 50 preferably contains a botanical item 60 such as a plant, preferably an orchid, which has an upper end 62 comprising blooms or foliage or both.

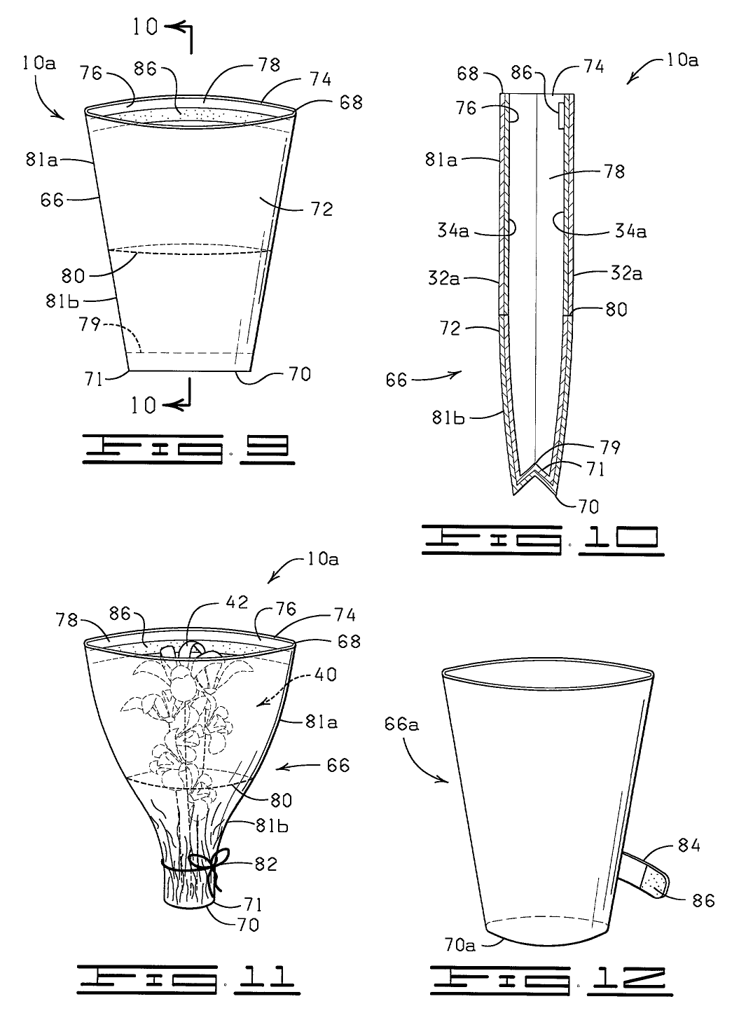

The sheet of material 12 may be wrapped about the pot 50 by any one of numerous methods used to wrap sheets of material about pots to form decorative pot covers. The sheet of material 12 may, for example, be formed by hand about the outer peripheral surface 56 of the pot 50 and held thereto, for example, by a bonding element or material such as described elsewhere herein. For example, the wrapper 10 could be held about the pot 50 by a band 64 such as shown in FIG. 8. The band 64 could be applied manually or automatically such as by the method shown in U.S. Pat. No. 5,105,599, which is hereby expressly incorporated herein by reference. The band 64 could be applied as a tie using a method such as described in “Single Station Covering and Fastening System”, U.S. Pat. No. 5,609,009, the specification of which is hereby expressly incorporated herein by reference. The sheet of material 12 could be applied automatically about the pot 50, for example, by methods shown in U.S. Pat. Nos. 4,733,521 and 5,291,721, both of which are hereby expressly incorporated herein by reference.

The term “bonding material” when used herein can mean an adhesive, frequently a pressure sensitive adhesive, or a cohesive or any adhesive/cohesive combination, having adhesive qualities sufficient to cause the attachment of a portion of the sheet of material 12 to itself, to a floral grouping 40, or to a pot 50. Since the bonding material may be either an adhesive, cohesive, or an adhesive/cohesive combination, it will be appreciated that both adhesives and cohesives are known in the art, and both are commercially available. When the bonding material is a cohesive, a similar cohesive material must be placed on an adjacent surface for bondingly contacting and bondingly engaging with the cohesive material. The term “bonding material” also includes materials which are heat sealable and, in this instance, the adjacent portions of the material must be brought into contact and then heat must be applied to effect the seal. The term “bonding material” also includes materials which are sonic sealable and vibratory sealable. The term “bonding material” when used herein also means a heat sealing lacquer or hot melt material which may be applied to the material and, in this instance, heat, sound waves, or vibrations, also must be applied to effect the sealing.

The term “bonding material” when used herein also means any type of material or thing which can be used to effect the bonding or connecting of the two adjacent portions of the material or sheet of material to effect the connection or bonding described herein. The term “bonding material,” therefore, may also include ties, labels, bands, ribbons, strings, tapes (including single or double-sided adhesive tapes), staples or combinations thereof. Some of the bonding materials would secure the ends of the material while other bonding material may bind the circumference of a wrapper 10, or a sleeve 66, or, alternatively and/or in addition, the bonding materials would secure overlapping folds in the wrapper 10 and/or sleeve 66. Another way to secure the wrapper 10 and/or sleeve 66 is to heat seal the ends of the material to another portion of the material. One way to do this is to contact the ends with an iron of sufficient heat to heat seal the material.

The term “bonding material” when used herein also means any heat or chemically shrinkable material, and static electrical or other electrical device, chemical welding device, magnetic device, mechanical or barb-type fastening device or clamps, curl-type characteristics of the film or materials incorporated in material which can cause the material to take on certain shapes, cling films, slots, grooves, shrinkable materials and bands, curl materials, springs, and any type of welding method which may weld portions of the material to itself or to the pot 50, or to both the material itself and the pot 50.

### Embodiments of FIGS. 9-16

Shown in FIGS. 9-11 is a wrapper designated therein by the general reference numeral 10a which comprises the flexible tubular sleeve 66 (also referred to herein simply as sleeve 66) constructed of the same material used to make the sheet of material 12 described hereinabove. The sleeve 66 may be used as a wrapper 10a for a floral grouping 40 or a pot 50. The sleeve 66 initially comprises a flexible flat collapsed piece of material which is openable in the form of a tube. Floral sleeves and their method of construction are well known in the floral industry. The sleeve 66 may be tapered to have, in its flattened state, an overall trapezoidal or modified trapezoidal shape, and when opened is substantially frusto-conical to coniform. It will be appreciated, however, that the sleeve 66 may comprise variations on the aforementioned shapes or may comprise significantly altered shapes such as square or rectangular, wherein the sleeve 66 when opened has a cylindrical form, as long as the sleeve 66 functions in accordance with the present invention in the manner described herein. The sleeve 66 (or any other sleeve disclosed herein) may have an angular or contoured portion.

The sleeve 66 has an upper end 68, a lower end 70, and an outer peripheral surface 72. The sleeve 66 has an opening 74 at the upper end 68 and may be open at the lower end 70, such as shown in FIG. 12, or closed with a bottom 71 at the lower end 70, such as shown in FIGS. 9 and 10. The sleeve 66 also has an inner peripheral surface 76 which, when the sleeve 66 is opened, defines and encompasses an inner retaining space 78. The sleeve 66 is constructed to have a sheet of waxy material 34a laminated to a support sheet of material 32a. The sheet of waxy material 34a faces the inner retaining space 78, and forms the inner peripheral surface 76. When the lower end 70 of the sleeve 66 has a closed lower end 70, a portion of the lower end 70 may be inwardly folded to form one or more gussets 79 for allowing the bottom 71 to be expandable, for example, for receiving the circular bottom of a pot 50 or growing medium or floral grouping 40.

The sleeve 66 is generally frusto-conically shaped, but the sleeve 66 may be, by way of example but not by way of limitation, cylindrical, frusto-conical, a combination of both frusto-conical and cylindrical, or any other shape, as long as the sleeve 66 functions as described herein as noted above. Further, the sleeve 66 may comprise any shape, whether geometric, non-geometric, asymmetrical and/or fanciful as long as it functions in accordance with the present invention. The sleeve 66 may also be equipped with drain holes (if having a closed bottom) or side ventilation holes (not shown), or can be made from gas permeable or impermeable materials. The sleeve 66 may optionally comprise perforations 80 for enabling the separation of an upper portion 81a of the sleeve 66 above the perforations 80 from a lower portion 81b of the sleeve 66 below the perforations 80.

The material from which the sleeve 66 is constructed is the same as previously described above for the sheet of material 12. Such materials used to construct the sleeve 66 are further described in U.S. Pat. No. 5,111,637, which is hereby expressly incorporated herein by reference. Any thickness of material may be utilized in accordance with the present invention as long as the sleeve 66 may be formed as described herein, and as long as the formed sleeve 66 may contain at least a portion of a pot 50 or a plant 60 or a floral grouping 40, as described herein. Additionally, an insulating material such as bubble film, preferably as one of two or more layers, can be utilized in order to provide additional protection for the item, such as the floral grouping 40, contained therein.

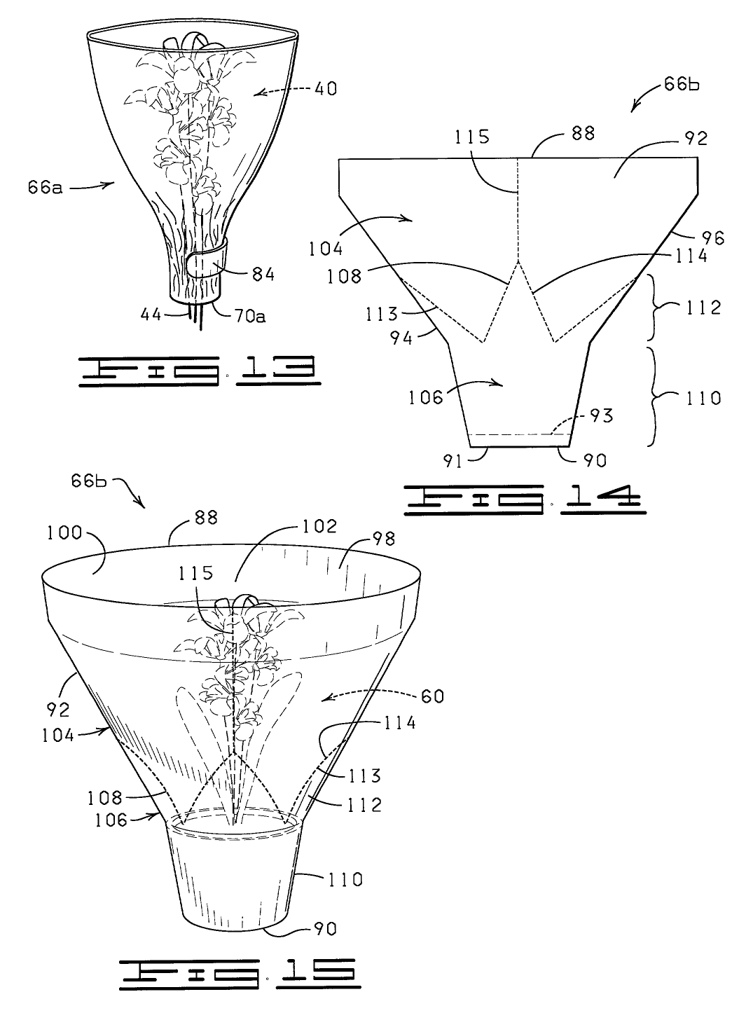

Shown in FIG. 11 is the sleeve 66 having a floral grouping 40 disposed within the inner retaining space 78 thereof. Generally, the upper portion 42 of the floral grouping 40 is disposed near the opening 74 of the sleeve 66 and the lower portion 44 of the floral grouping 40 is exposed near the lower end 70 of the sleeve 66. Either upper or lower end 68 or 70 of the sleeve 66 may be closed about the floral grouping 40. Generally, a portion of the sleeve 66 is tightened about a portion of the lower portion 44 of the floral grouping 40 for holding the sleeve 66 about the floral grouping 40. For example, the sleeve 66 may be held by a string, band or tie 82 tied about the sleeve 66 such as is shown in FIG. 11. Other devices for binding the sleeve 66 may be employed such as the bonding materials described elsewhere herein. For example, a sleeve such as sleeve 66a with an open lower end 70a in FIG. 12 has a cinching tab 84 having a bonding material 86 disposed upon a surface thereof. The cinching tab 84 can be used to gather portions of the sleeve 66a together about the lower portion 44 of the floral grouping 40 as shown in FIG. 13 for holding the sleeve 66a tightly about the lower portion 44 of the floral grouping 40.

Similarly, it may generally be desired to use the sleeve 66 to a wrapper for a pot 50. The pot 50 will generally contain a botanical item or plant 60. The pot 50 can be deposited into the lower portion 81b of the open sleeve 66 in a manner well known in the art such as manually wherein the sleeve 66 is opened by hand and the pot 50 deposited therein.

As noted above, a bonding material 86 may optionally be disposed on a portion of the sleeve 66 or any sleeve described herein to assist in holding the sleeve 66 to the pot 50 when such a pot 50 is disposed within the sleeve 66 or to assist in closing the upper end 68 of the sleeve 66 or adhering the sleeve 66 to the pot 50 after the pot 50 has been disposed therein, as will be discussed in further detail below.

It will be understood that the bonding material 86, if present, may be disposed as a strip or block on a surface of the sleeve 66. The bonding material 86 may also be disposed upon either the outer peripheral surface 72 or the inner peripheral surface 76 of the sleeve 66, as well as upon the pot 50. Further, the bonding material 86 may be disposed as spots of bonding material 86, or in any other geometric, non-geometric, asymmetric, or fanciful form, and in any pattern including covering either a portion of or the entire inner peripheral surface 76 and/or outer peripheral surface 72 of the sleeve 66 and/or the pot 50. The bonding material 86 may be covered by a cover or release strip which can be removed prior to the use of the sleeve 66 or pot 50. The bonding material can be applied by methods known to those of ordinary skill in their art. One method for disposing a bonding material 86, in this case an adhesive, is described in U.S. Pat. No. 5,111,637.

As noted above, a bonding material 86 may be disposed on at least a portion of the inner peripheral surface 76 of the sleeve 66 (or any other sleeve described herein). Alternatively, the bonding material 86 may be disposed on the outer peripheral surface 72 of a pot 50 contained within the sleeve 66, while the sleeve 66 may be free of the bonding material. In a another alternative embodiment, the bonding material 86 may be disposed both on at least a portion of the pot 50 as well as upon at least a portion of the inner peripheral surface 76 of the sleeve 66. In addition, a portion of the bonding material 86 may also be disposed on the outer peripheral surface 72 of the sleeve 66 as well. It will be understood that the bonding material 86 may be disposed in a solid section of bonding material. The bonding material 86, when present, is disposed on the sleeve 66 and/or pot 50 by any method known in the art.

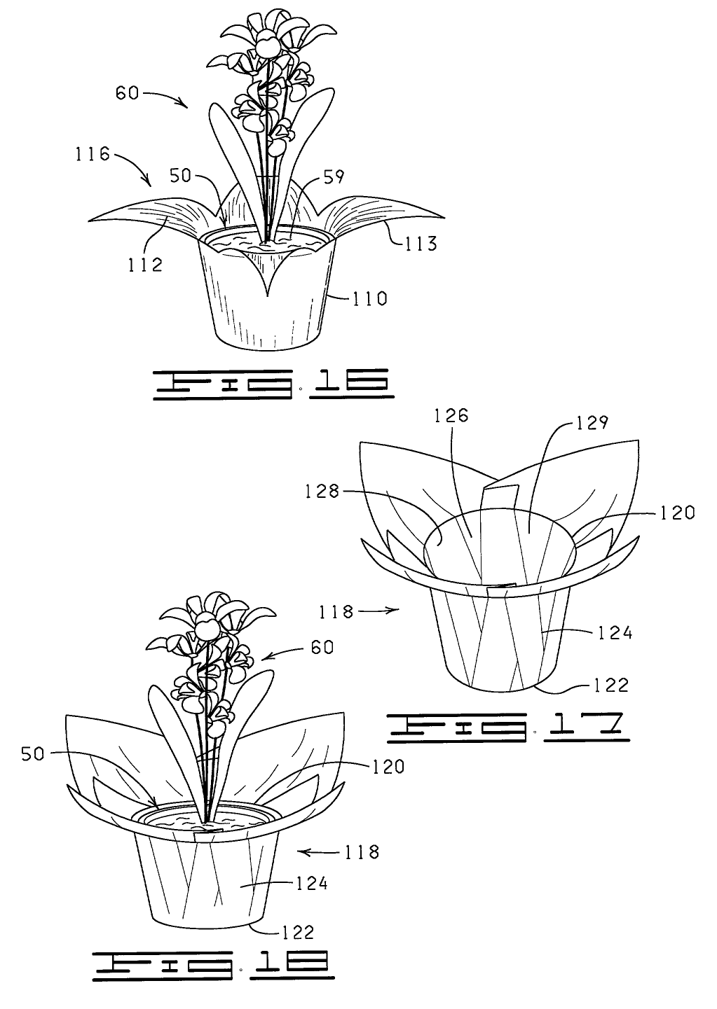

Shown in FIGS. 14 and 15 is another wrapper comprising a sleeve constructed in accordance with the present invention and designated by the general reference numeral 66b. The sleeve 66b has a “detaching” element 108 in predetermined areas for detaching a portion of the sleeve 66b. The sleeve 66b generally initially comprises a flexible flat collapsed piece of material having sealed side edges 94 and 96 and which is openable in the form of a tube or sleeve. The sleeve 66b is constructed of the same material and in essentially the same way as described previously herein for sleeve 66 or 66a described elsewhere herein except for the additional elements described herein.

The sleeve 66b has an upper end 88, a lower end 90, an outer peripheral surface 92 and in its flattened state has a first side 94 and a second side 96. The sleeve 66b has an opening 98 at the upper end 88 and may be open at the lower end 90, or closed with a bottom 91 at the lower end 90. The sleeve 66b also has an inner peripheral surface 100 which, when the sleeve 66b is opened, defines and encompasses an inner retaining space 102 as shown in FIG. 15. When the lower end 90 of the sleeve 66b has a bottom 91 in the lower end 90, the lower end 90 may have one or more gussets 93 for permitting a circular bottom of an object such as a pot 50 to be disposed into the inner retaining space 102 of the sleeve 66b.

As shown in FIGS. 14 and 15, the sleeve 66b is demarcated into an upper portion 104 and a lower portion 106. The lower portion 106 of the sleeve 66b is generally sized to contain the pot 50. The upper portion 104 of the sleeve 66b is sized to substantially surround and encompass a plant 60 contained in the pot 50 disposed within the lower portion 106 of the sleeve 66b. The sleeve 66b is demarcated into the upper portion 104 and the lower portion 106 by the detaching element 108 for enabling the detachment of the upper portion 104 of the sleeve 66b from the lower portion 106 of the sleeve 66b. In the present version, the detaching element 108 is a plurality of generally laterally-oriented, alternatingly diagonally-oriented, or curved or non-linear perforations which extend circumferentially across the outer peripheral surface 92 of the sleeve 66b from the first side 94 to the second side 96. The detaching element 108 may also be linear across the outer peripheral surface 92.

In a preferred embodiment, as shown in FIGS. 14 and 15, the lower portion 106 of the sleeve 66b comprises a base portion 110 and a skirt portion 112. The base portion 110 comprises that part of the lower portion 106 which, when the pot 50 is placed into the lower portion 106 is substantially adjacent to and surrounds the outer peripheral surface 56 of the pot 50. The skirt portion 112 comprises that part of the lower portion 106 which extends beyond the upper end 52 of the pot 50 and adjacent at least a portion of the plant 60 contained within the pot 50 and which is left to freely extend at an angle, inwardly or outwardly, from the base portion 110 when the upper portion 104 of the sleeve 66b is detached from the lower portion 106 by actuation of the detaching element 108.

In the intact sleeve 66b, the skirt portion 112 comprises an upper peripheral edge 113 congruent with the detaching element 108 which is connected to a lower peripheral edge 114, also congruent with the detaching element 108, of the upper portion 104 of the sleeve 66b. In FIGS. 14 and 15, the upper peripheral edge 113 of the skirt portion 112 is congruent with a series of alternating diagonally-oriented lines of perforations which together form a zig-zag and comprise the detaching element 108. The upper portion 104 of the sleeve 66b may also have a vertical detaching element 115 indicated as a plurality of vertical perforations for facilitating removal of the upper portion 104 and which are disposed more or less vertically therein extending between the detaching element 108 of the sleeve 66b and the upper end 88.

The upper portion 104 of the sleeve 66b is separable from the lower portion 106 of the sleeve 66b by tearing the upper portion 104 along both the vertical detaching element 115 and the detaching element 108, thereby separating the upper portion 104 from the lower portion 106 of the sleeve 66b. The lower portion 106 of the sleeve 66b remains disposed as the base portion 110 about the pot 50 and as the skirt portion 112 forming a decorative cover 116 as shown in FIG. 16 which substantially surrounds and encompasses the pot 50. In one version of the invention, only the skirt portion 112 and upper portion 104 of the sleeve may be constructed of the laminate of waxy material, while the base portion 110 is constructed of another material.

“Detaching element,” as used herein, means any element, or combination of elements, or features, such as, but not by way of limitation, perforations, tear strips, zippers, and any other devices or elements of this nature known in the art, or any combination thereof. Therefore, while perforations are shown and described in detail herein, it will be understood that tear strips, tear starts, zippers, or any other “detaching elements” known in the art, or any combination thereof, could be substituted therefor and/or used therewith.

In a general method of use of sleeves 66-66b as a wrapper for a pot 50, an operator provides a sleeve 66-66b, and a pot 50 having a plant 60 disposed in a growing medium 59 contained within the pot 50. The operator then disposes the pot 50 having the plant 60 contained therein into an opened sleeve 66-66b. The sleeve 6666b may be equipped with holes to facilitate the carrying or support of the sleeve 66-66b on rods, or wickets or another support device, and the pot 50 then being disposed in the sleeve 66-66b either before or after the sleeve 66-66b has been removed from the support device.

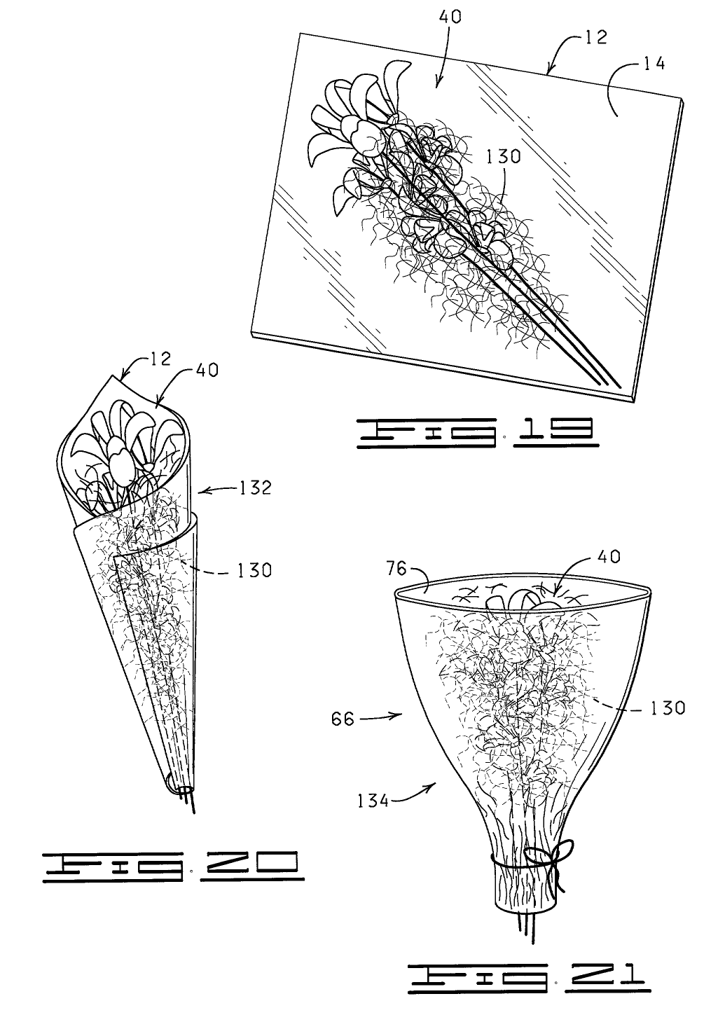

### Embodiments of FIGS. 17-18

In another version of the invention, the wrapper may be a decorative preformed plant cover which is used to substantially surround and encompass a pot 50. Shown in FIG. 17 is a decorative preformed pot cover designated by the numeral 118.

The decorative preformed pot cover 118 has an upper end 120, a lower end 122, and an outer peripheral surface 124. An opening 126 intersects the upper end 120, forming an inner peripheral surface 128 which defines and encompasses a retaining space 129 within which the pot 50 and plant 60 may be disposed in a manner well known in the art and which is shown in FIG. 18.

Methods for forming such decorative preformed pot covers 118 are well known in the art. Two methods of forming such covers are described in U.S. Pat. Nos. 4,773,182 and 5,291,721, both of which are hereby expressly incorporated herein by reference herein.

Further, in accordance with the present invention, the decorative preformed pot cover 118 is constructed from the same materials described herein above for the construction of the sheet of material 12 or the sleeves 66-66b and may have a bonding material disposed upon a portion thereof.

### Embodiments of FIGS. 19-21

In an alternate version of the invention, the floral grouping may be wrapped with a quantity of a shredded material 130 for providing a cushion when the floral grouping 40 is wrapped with the sheet of material 12a or with a sleeve 66, as described above. The shredded material 130 is preferably formed by shredding the same material as comprises the sheet of material 12. The shredded material 130 may be any shredded material, such as paper or polymeric film, which functions to cushion the floral grouping 40 within the sheet of material 12a or sleeve 66. The material may be shredded by any method well known in the art, for example, using a paper shredding device. The shredded material 130 may be placed upon the wrapping surface 14a of the sheet of material 12a along with a floral grouping 40, as shown in FIG. 19. The sheet of material 12a is then wrapped about the floral grouping 40 and the shredded material 130 in a manner described above to form a wrapped floral grouping 132, such as is shown in FIG. 20.

Alternatively, the shredded material 130 may be placed within the inner space of a sleeve 66 along with a floral grouping 40 and the sleeve 66 wrapped about the floral grouping 40 and shredded material 130 in a manner disclosed above to form a wrapped floral grouping 134, such as is shown in FIG. 21.

In one version of the sheet of material 12a shown in FIG. 19, the wrapping surface 14a comprises the exposed surface of any one of the materials described above which may be used in the construction of any one of the layers of the sheet of material 12. Preferably, the wrapping surface 14a of the sheet of material 12a comprises a sheet of a waxy material, as described elsewhere herein.

In one version, shown in FIG. 21, the inner peripheral surface 76 of the sleeve 66 comprises the exposed surface of any one of the materials described above including those having a waxy material connected or laminated thereto which may be used in the construction of any one of the first waxy sheet of material 34 or the support sheet of material 32 used to construct the sheet of material 12. Preferably, the inner peripheral surface 76 of the sleeve 66 comprises a sheet of a waxy material connected or laminated to a support sheet of material as described above. The shredded material 130 may be used, alternatively, with any type of sleeve described herein or known elsewhere in the art.

Changes may be made in the construction and the operation of the various components, elements and assemblies described herein or in the steps or the sequence of steps of the methods described herein without departing from the spirit and scope of the invention as defined in the following claims.

What is claimed is:

1. A wrapper for wrapping a floral grouping, comprising:
a flexible sleeve having an outer surface and an inner surface surrounding an inner space, the sleeve constructed from a laminate of a first sheet of waxy material and a support sheet of material, the first sheet of waxy material constructed from a waxy material and superposed upon a first surface of the support sheet of material and laminated thereto and with the inner surface of the sleeve comprising the first sheet of waxy material, and wherein the sleeve, when wrapped about the floral grouping, is less compressible about the floral grouping than a sleeve formed from the first sheet of waxy material alone; and
wherein when the sleeve is placed about the floral grouping, the first sheet of waxy material is positioned adjacent at least a portion of the bloom portion and the sleeve substantially encompasses the bloom portion, the sleeve having an upper end and a lower end.

2. The wrapper of claim 1 wherein the sleeve is constructed from a transparent, translucent or opaque laminate.

3. The wrapper of claim 1 wherein the sleeve is further defined as constructed from a laminate having a thickness in a range of from about 0.1 mil to about 30 mils.

4. The wrapper of claim 1 wherein the sleeve is further defined as constructed from a laminate having a thickness in a range of from about 0.5 mil about 10 mils.

5. The wrapper of claim 1 wherein the sleeve is further defined as constructed from a laminate having a thickness in a range of from about 1 mil to about 5 mils.

6. The wrapper of claim 1 wherein the support sheet of material of the sleeve is defined as constructed from a selected from the group consisting of treated or untreated paper, metal foil, polymeric film, non-polymeric film, cardboard, cloth, burlap, and laminations or combinations thereof.

7. The wrapper of claim 1 wherein the laminate from which the sleeve is constructed further comprises a second sheet of waxy material laminated to a second surface of the support sheet of material, and wherein the second sheet of waxy material is the same as the first sheet of waxy material or is different from the first sheet of waxy material.

8. The wrapper of claim 1 wherein the sleeve is further defined as having a portion which is detachable via a detaching element.

9. The wrapper of claim 1 wherein the sleeve has a bonding material thereon for bondingly connecting a portion of the sleeve together for holding the sleeve in a wrapped position about the floral grouping.

10. The wrapper of claim 1 wherein the upper end of the sleeve is closable.

11. The wrapper of claim 1 wherein the lower end of the sleeve is closable.

12. The wrapper of claim 1 wherein both the upper end and the lower end of the sleeve are closable.

13. The wrapper of claim 1 wherein the sleeve further comprises holes therein for ventilation or drainage.

14. The wrapper of claim 1 wherein the sleeve is further defined as comprising as gusseted or sealed lower end.

15. The wrapper of claim 1 wherein under ordinary handling conditions the sleeve substantially prevents damage to the bloom portion of the floral grouping by crushing.
